(19) United States
(12) Patent Application Publication
(10) Pub. No.: US 2001/0021088 A1
(43) Pub. Date: Sep. 13, 2001

(54) Magnetoresistive head and magnetic storage apparatus

(76) Inventors: Katsumi Hoshino, Matsuda (JP); Nobuo Yoshida, Odawara (JP)

Correspondence Address: MATTINGLY, STANGER & MALUR, P.C., 104 East Hume Avenue, Alexandria, VA, 22301, US

(21) Appl. No.: 09/799,567

(22) Filed: Mar. 7, 2001

(30) Foreign Application Priority Data
Mar. 9, 2000 (JP) 2000-065669

(51) Int. Cl. G11B 5/39

(52) U.S. Cl. 360/320; 360/317

(57) ABSTRACT

The present invention has an objective of providing a highly reliable magnetoresistive head adapted to a high recording density, at an enhanced yield.

A laminated structure of a highly-resistive film (2, 3, 4 and/or 5) such as a semiconductor and an insulating film 1 made of or mainly made of Al₂O₃, SiO₂, AlN or Si₃N₄ is employed as a lower gap film or an upper gap film.

### FIELD OF THE INVENTION

The present invention relates to a magnetic head and a magnetic storage apparatus adapted to a high magnetic recording density.

### BACKGROUND OF THE INVENTION

Current magnetic disk apparatuses employ a recording/reading separation type head which writes data with an inductive thin-film head and reads out data with a magnetoresistive head. The magnetoresistive head utilizes magnetoresistive effect where an electric resistance changes depending upon an external magnetic field. As shown in FIG. 2, a magnetoresistive head is provided with: a magnetoresistive element including a magnetoresistive film 14, longitudinal bias layers 15 and electrodes 16; lower and upper shielding films 12 and 18 for shielding unnecessary magnetic field; and gap insulating films 13 and 17 for insulating the element from the shielding films 12 and 18, respectively. The gap insulating films are mainly made of Al₂O₃ films.

As an alternative material for Al₂O₃, Japanese Laid-Open Patent Application No. 9-44815 discloses an Al₂O₃ film whose oxygen content alters in the depth direction, thereby minimizing the stress. Japanese Laid-Open Patent Application No. 11-39614 discloses an insulating material obtained by laminating insulating layers each having with a thickness of 1 nm or less. Furthermore, Japanese Laid-Open Patent Applications Nos. 9-198619 and 10-324969 describe a method for forming an insulating film by oxidizing a metal film.

As a magnetic recording density becomes higher, the gap length between the lower and upper shielding films needs to be made smaller by making thinner gap insulating films to enhance the resolution of the magnetoresistive head. In this case, a problem occurs when a dielectric breakdown strength is so low as to cause short-circuit between the magnetoresistive film and/or the electrodes and the shielding films. Although an Al₂O₃ film is known as a major material for the above-mentioned gap insulating films, it has a problem that as the insulating film gets thinner, influences resulting from roughness, pinholes, film deficiency and the like of the film become larger, causing a rapid deterioration of the dielectric breakdown field.

In view of the above-described prior art problems, the present invention has an objective of providing at an enhanced yield a highly reliable magnetoresistive head adapted to a high recording density. The present invention also has an objective of providing a high-performance magnetic storage apparatus incorporating such a magnetic head.

### SUMMARY OF THE INVENTION

The present inventors have studied a structure of a magnetoresistive head having an excellent dielectric breakdown resistance between a magnetoresistive film and a magnetic shielding film. As a result, they found out that a concentration of the electric field caused by roughness, pinholes, film deficiency and the like of the insulating film can be minimized and thus there is a less chance of dielectric breakdown, when a lower gap film and/or an upper gap film is made of a laminated structure of an insulating film made of or mainly made of Al₂O₃, SiO₂, AlN or Si₃N₄ and a highly-resistive film such as a semiconductor whose leakage current increases as a voltage is applied. They also found out that the leakage current can be suppressed as much as possible when the highly-resistive film is made of a material such as Ni—O, Fe—O, Co—O, Si, SiC, ZnO or the like. Accordingly, they have achieved the present invention.

A magnetoresistive head of the invention comprises a magnetoresistive element having a magnetoresistive film for converting a magnetic signal into an electric signal and a pair of electrodes for passing a detection current to the magnetoresistive film, the magnetoresistive element being provided between an upper shielding film and a lower shielding film via an upper gap film and a lower gap film, respectively, wherein the lower gap film and/or the upper gap film has a laminated structure of a highly-resistive film and an insulating film made of or mainly made of Al₂O₃, SiO₂, AlN or Si₃N₄.

Three types of structures are schematically shown in FIGS. 1A to 1C as the laminated structure consisting of the insulating film and the highly-resistive film, which can be used as the lower gap film and/or the upper gap film. Specifically, the laminated structure shown in FIG. 1A has an insulating film 1 formed on a highly-resistive film 2, the laminated structure shown in FIG. 1B has a highly-resistive film 3 formed on an insulating film 1, and the laminated structure shown in FIG. 1C has an insulating film 1 and a highly-resistive film 5 formed on a highly-resistive film 4.

The highly-resistive film may have an electric resistance of 0.01 Ωcm or higher and may be made of or mainly made of Si, SiC, ZnO, Ni—O, Fe—O or Co—O.

The magnetoresistive head of the invention may be combined with an inductive thin-film head to provide a recording/reading separation type head of a magnetic storage apparatus.

According to the present invention, a highly reliable head adapted to a high recording density can be provided at an enhanced yield. Furthermore, this magnetic head may be used to produce a high-performance magnetic storage apparatus.

### BRIEF DESCRIPTION OF THE DRAWINGS

FIGS. 1A to 1C are schematic cross-sectional views for illustrating a laminated structure of a gap film;

FIG. 2 is a schematic cross-sectional view showing an exemplary magnetoresistive head seen from a medium side;

FIGS. 3A and 3B are schematic views showing structures of magnetic gap films according to prior art and the present invention, respectively;

FIG. 4 is a schematic view for illustrating a method for measuring an dielectric breakdown resistance;

FIGS. 5A and 5B are graphs showing relationships between a thickness of a magnetic gap film and an insulation breakdown voltage, according to prior art and the present invention, respectively;

FIG. 6 is a graph for comparing yield of elements according to the present invention and prior art;

FIGS. 7A and 7B are schematic views for illustrating another method for producing a laminated film;

FIG. 8 is a graph showing dependency of an dielectric breakdown voltage of a magnetic gap film of the present invention on a thickness of an Si layer;

FIG. 9 is a graph showing yield of elements according to the present invention and prior art;

FIG. 10 is a perspective view showing a magnetic head comprising a magnetoresistive head and a recording head; and

FIGS. 11A and 11B are schematic views showing a magnetic storage apparatus.

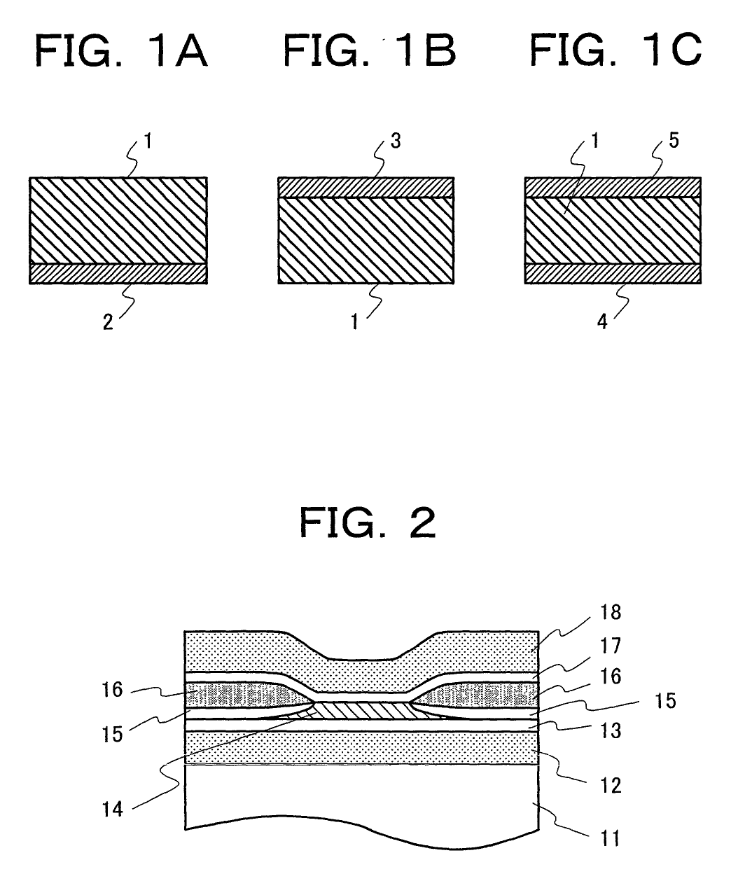

### DETAILED DESCRIPTION OF THE INVENTION

Hereinafter, embodiments of the present invention will be described with reference to the accompanying drawings. Herein, a laminated film consisting of a layer A having a thickness of a and a layer B having a thickness of b, where the layer B is formed on the layer A and the layer A is closer to the substrate, is represented as B/A, or B(b)/A(a). A laminated film consisting of three layers is also represented in a similar manner

### EXAMPLE 1

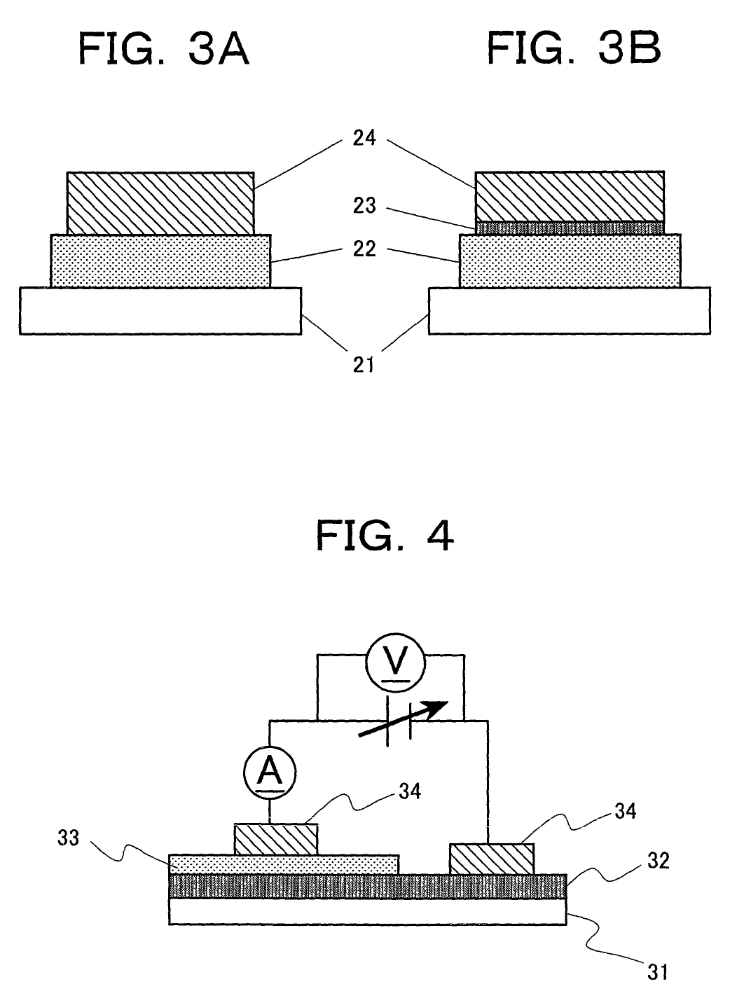

An SiO₂ single-layer film and an SiO₂/Si double-layer film were produced as gap films by RF sputtering method from Si and SiO₂ targets in a same chamber. FIGS. 3A and 3B are schematic cross-sectional views of the produced films. FIG. 3A shows a structure of a gap film, (SO₂ single-layer) for comparison which has an Si substrate 21, an NiFe shielding film 22 with a thickness of 0.1 μm and an SiO₂ insulating film 24 formed in this order. FIG. 3B shows a structure of a gap film (SiO₂/Si double-layer film) of the present example which has an Si substrate 21, an NiFe shielding film 22 with a thickness of 0.1 μm, a highly-resistive film 23 made of Si and an SiO₂ insulating layer 24 formed in this order. The electric resistance of Si was about 100 Ωcm.

The SiO₂ film and the SiO₂/Si double-layer film shown in FIGS. 3A and 3B were used to study the relationships between the thicknesses of the SiO₂ and SiO₂/Si gap films and dielectric breakdown voltages. Evaluations were made as follows. As shown in FIG. 4, an NiFe lower electrode film (thickness of 1 μm) 32, a gap film 33 and an Al upper electrode film (thickness of 1 μm×1 mmø) 34 were sequentially formed on a substrate 31. Then, a voltage was applied between the lower electrode film and the upper electrode film to measure a leakage current resulting therefrom. When the SiO₂/Si double-layer film was used as the gap film 33, the thickness of Si was set to 2 nm.

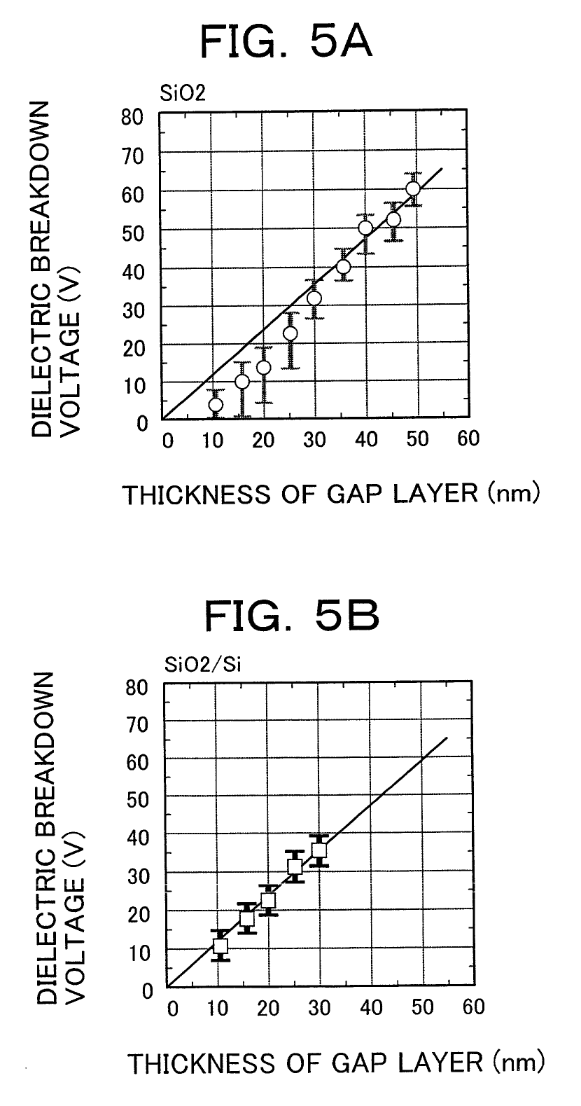

FIGS. 5A and 5B are graphs showing relationships between the thickness and the dielectric breakdown voltage of the SiO₂ single-layer film and the SiO₂/Si double-layer film as the gap films, respectively. As shown in FIG. 5A, the dielectric breakdown voltage of the SiO₂ single-layer film rapidly drops when the thickness of the SiO₂ single-layer film becomes 30 nm or less. On the other hand, as shown in FIG. 5B, there is no rapid drop of the dielectric breakdown voltage in the case of the SiO₂/Si double-layer structure even when the gap film is thin.

The double-layer film was used as the magnetic gap films of the magnetoresistive element shown in FIG. 2. A voltage is applied between the upper and lower shielding films and the magnetoresistive film to observe the breakdown resistance of the element. In the present example, a magnetoresistive head using the SiO₂/Si double-layer film as one gap film 13 and the SiO₂ single-layer film as the other gap film 17 was produced. A magnetoresistive head using the SiO₂ single-layer films as the gap films 13 and 17 was also produced for comparison.

The reading magnetic head of the present example was produced as follows. First, an Ni—Fe lower shielding film 12 was formed to a thickness of 2.0 μm on a non-magnetic substrate 11 which was obtained by finely polishing an insulating thin film such as an Al₂O₃ thin film. On the obtained layers, the double-layer film made of SiO₂(18 nm)/Si(2 nm) shown in FIG. 3 and a multilayer spin-valve film were formed as a lower gap film 13 and a magnetoresistive film 14, respectively. The film structure of the magnetoresistive film 14 was [Ta(3 nm)/Ni—Fe(2 nm)/Co(0.5 nm)/Cu(2 nm)/Co(1 nm)/Ru(0.7 nm)/Co(2 nm)/Mn—Pt(12 nm)] with Mn—Pt being on the substrate side and Ta being the farthest from the substrate. Then, the magnetoresistive film 14 was patterned into a desired shape by an ion milling technique, and then Co—Pt longitudinal bias layers 15 for suppressing Barkhausen noise and Ta/TaW electrodes 16 were formed. On the obtained layers, an SiO₂ upper gap film 17 with a thickness of 30 nm and an Ni—Fe upper shielding film 18 with a thickness of 3.0 μm were formed.

The reading magnetic head for comparison was made from the same materials under the same conditions as those of the magnetic head of the present example except that an SiO₂ film (20 nm) was used as the lower gap film 13.

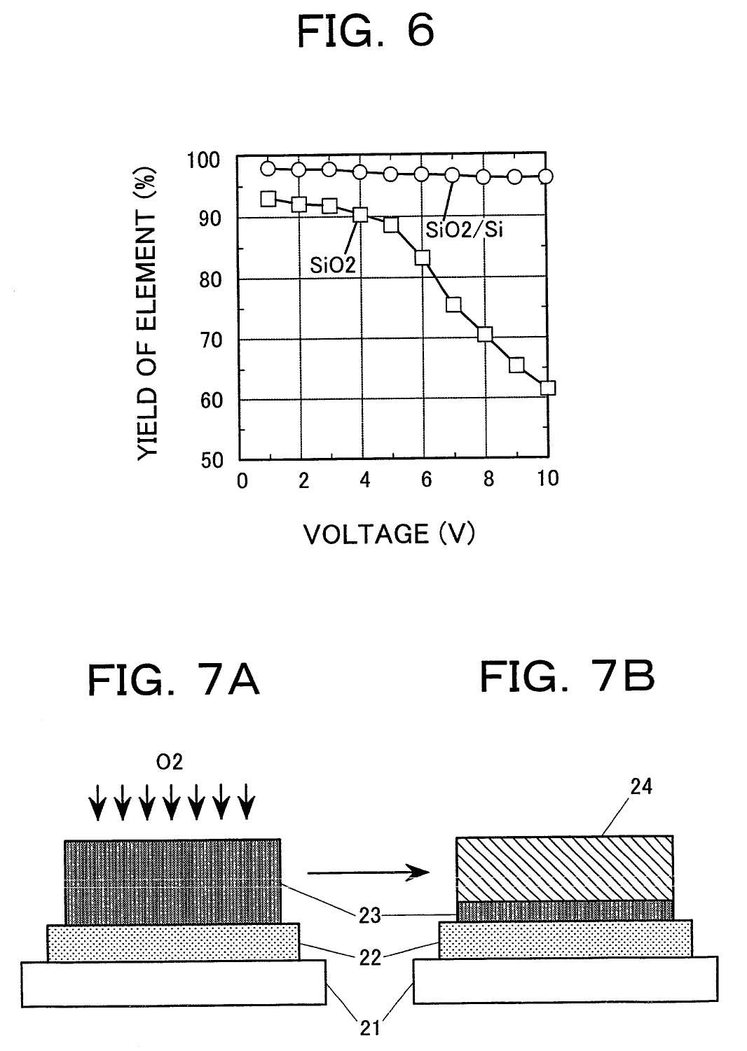

FIG. 6 is a graph showing yield of the magnetoresistive elements obtained by altering the voltage applied between the upper and lower shielding films and the magnetoresistive film 14 between 1 V to 10 V. An yield is a percentage of elements that normally functioned as magnetoresistive elements among the produced elements. As shown in FIG. 6, the percentage of non-destructed elements upon an application of a high voltage increases when the gap film is a double-layer film and thus a magnetoresistive head with an excellent insulation performance can be provided.

Although the thickness of the Si layer is 2 nm in the present example, the thickness of the Si layer may be thinner than 2 nm when the Si layer is formed as a continuous layer. As the Si layer becomes thicker, the SiO₂ layer becomes thinner, which results in deterioration of the dielectric breakdown resistance of the whole gap film. Therefore, the thickness of the Si layer is preferably as thin as possible to be less than 4 nm.

Although an Si/SiO₂ double-layer film is described herein, same results can be obtained when the Si layer is replaced with a layer made of or mainly made of SiC or ZnO, or when the SiO₂ layer is replaced with a layer made of or mainly made of Al₂O₃, Si₃N₄ or AlN. Although the Si layer as a highly-resistive film is formed first (formed closer to the substrate) in the present example, the SiO₂ layer as an insulating film may be formed first to obtain the same results. However, it is preferable to form the Si highly-resistive film first, since the quality of the SiO₂ layer can thus be enhanced and the resulting insulation yield becomes slightly higher.

### EXAMPLE 2

An Si layer was oxidized to obtain an SiO₂ insulating layer for producing an SiO₂/Si double-layer film. First, as shown in FIG. 7A, an NiFe lower shielding film 22 was formed to a thickness of 0.1 μm on an Si substrate 21, on which an Si layer 23 was formed with RF sputtering method from Si target. Thereafter, the Si layer oxidized from its surface by discharging oxygen plasma to produce an SiO₂/Si film (to a total thickness of 20 nm) shown in FIG. 7B. Since the SiO₂ film is produced by oxidizing the Si layer, the SiO₂ film becomes thicker than that of the originally formed Si layer. Therefore, the thickness of the SiO₂/Si film was examined after oxidization by X-ray reflectometory method.

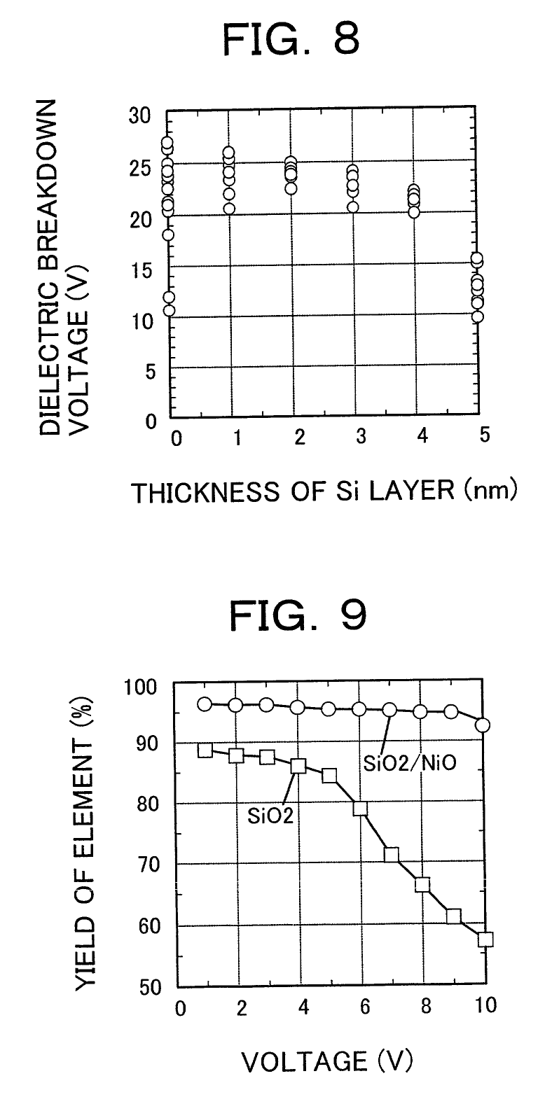

FIG. 8 shows the results of examined dependency of an dielectric breakdown voltage on a thickness of the Si layer where the thickness of the SiO₂/Si double-layer was set to 20 nm. As the oxidation time becomes shorter, the SiO₂ layer becomes thinner and thus the dielectric breakdown voltage becomes lower. By setting the oxidization time such that the thickness of the Si layer becomes about 1 nm to 4 nm, a gap film that exhibits a high dielectric breakdown voltage can stably be produced.

As shown in FIG. 7B, the present example employs a complete double-layer structure of an SiO₂ layer and an Si layer. However, the interface between the Sio₂ layer and the Si layer may have a slight amount of an Si—O layer resulting from an insufficient amount of oxygen.

### EXAMPLE 3

In the same manner as Example 1, the dielectric breakdown resistance of the magnetoresistive element having the structure shown in FIG. 2 was measured. According to the present example, the gap films 13 and 17 were made of SiO₂/Nio double-layer films. The electric resistance of NiO was about 10 kΩ cm.

First, an Ni—Fe lower shielding film 12 was formed to a thickness of 2.0 μm on a non-magnetic substrate 11 which was obtained by finely polishing an insulating thin film such as an Al₂O₃ thin film. An SiO₂(17 nm)/NiO(3 nm) double-layer film was formed as the lower gap film 13. Then, a multilayer spin-valve film was formed as a magnetoresistive film 14. The film structure of the magnetoresistive film 14 was [Cu(1 nm)/Ni—Fe(2 nm)/Co(0.5 nm)/Cu(2 nm)/Co(1 nm)/Ru(0.7 nm)/Co(2 nm)/Mn—Pt(12 nm)]. the magnetoresistive film 14 was patterned into a desired shape by an ion milling technique, and then Co—Pt longitudinal bias layers 15 for controlling Barkhausen noise and Ta/TaW electrodes 16 were formed. On the obtained layers, an SiO₂(25 nm)/NiO(5 nm) upper gap film 17 and an Ni—Fe upper shielding film 18 with a thickness of 3.0 μm were formed. Since the NiO layer used as the gap film herein was very thin, it did not act as an anti-ferromagnetic layer.

FIG. 9 is a graph showing yield of the element obtained by altering the applied voltages up to 10 V. As represented in the graph, the gap films 13 and 17 having a double-layer structure of a highly-resistive film and an insulating layer had an increased rate of non-destructed elements upon a voltage application and thus they can provide a magnetoresistive head with an excellent insulation performance as compared to the case where SiO₂ single-layers were used as the upper and lower gap films.

Although an Ni—O/SiO₂ double-layer film is described in the present example, the same results can be obtained by using Fe—O, Co—O or a combination thereof instead of Ni—O as a material for the highly-resistive film, or by using a layer made of or mainly made of Al₂O₃, Si₃N₄ and AlN instead of SiO₂ layer as the insulating film. Furthermore, although NiO is formed on the substrate side in the present example, the same results may be obtained when NiO is formed on the surface side. However, the insulation yield seemed to be slightly higher when NiO was formed on the substrate side.

### EXAMPLE 4

The magnetoresistive head produced in Example 1 and a recording head (an inductive head) were combined to produce a recording/reading separation type head.

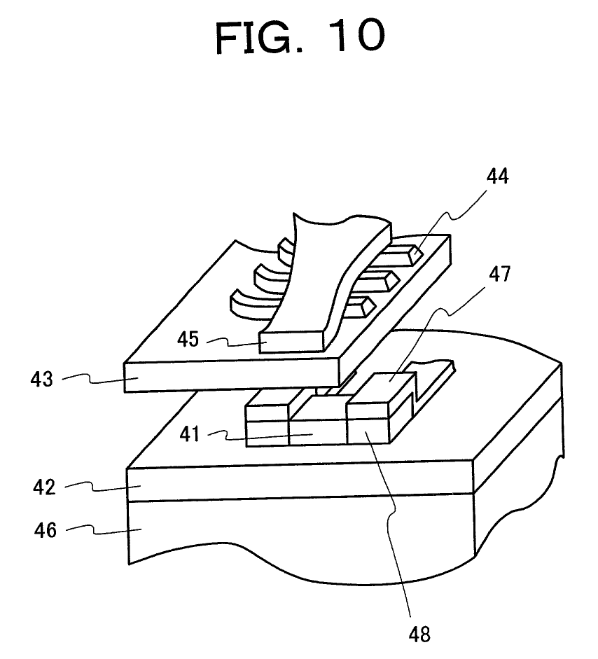

FIG. 10 is a partially cutaway perspective view showing a recording/reading separation type head produced in the present example. A lower shielding film 42 was formed on a substrate 46. A magnetoresistive film 41 was arranged between the lower shielding film 42 and an upper shielding film 43. Longitudinal bias layers 48 were formed on both sides of the magnetoresistive film 41 together with electrodes 47. The part between the lower and upper shielding films 42 and 43 functioned as the reading head which has the same structure as that described in Example 1. A lower magnetic pole of the recording head also served as the upper shielding film 43 of the reading head. A coil 44 and an upper magnetic pole 45 of the recording head are made of Cu and 46 wt % Ni-Fe layers by electroplating, respectively. The magnetic gap film and a protective film of the recording head was made of Al₂O₃. The track width of the recording head was 0.4 μm and the track width of the reading head was 0.3 μm.

The magnetic head of the invention uses a magnetic gap film having an dielectric breakdown voltage higher than that of a conventional magnetic gap film. Accordingly, a magnetic head can be produced at a high yield.

### EXAMPLE 5

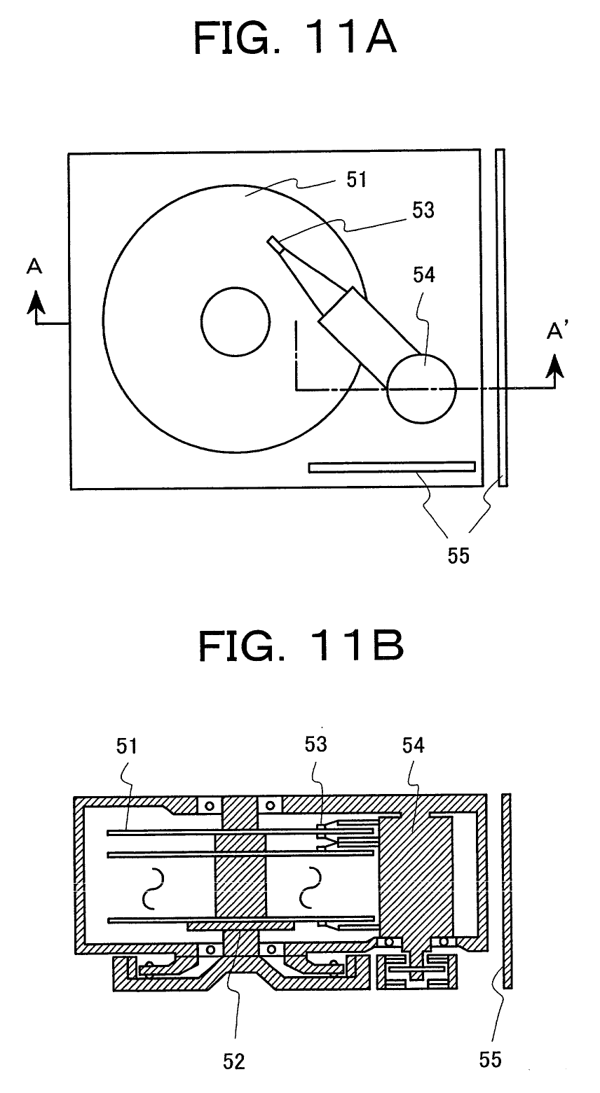

The recording/reading separation type head of the invention was used to produce a magnetic storage apparatus. A structure of the magnetic storage apparatus is schematically shown in FIGS. 11A and 11B. FIG. 11A is a plan view of the magnetic storage apparatus, and FIG. 11B is a cross-sectional view of the magnetic storage apparatus cut along line A-A′ in FIG. 11A.

The magnetic storage apparatus has a well-known structure mainly consisting of: a disk-shaped magnetic recording medium 51 which has a magnetic recording film and which rotates with respect to its center axis; a magnetic head 53 for recording/reading data on/from the magnetic recording medium; a mechanism for supporting and aligning the magnetic head 53 at a desired radial position on the magnetic recording medium; and a recording/reading signal processing system 55 for processing recording signals and reading signals.

The magnetic recording medium 51 is secured to and rotated by a magnetic recording medium driver 52. The magnetic head 53 is supported by suspension supported by an arm secured to a magnetic head driver 54. The magnetic head 53 can be aligned at a desired position on the magnetic recording medium 51 by rotating the magnetic head driver 54. The recording/reading signal processing system 55 records data by passing a recording current to the magnetic head 53 and processes electric signals obtained from the magnetic head 53 to convert them into data. Data is recorded by magnetization reversal of the magnetic film on the magnetic recording medium by utilizing the change of the recording magnetic field corresponding to the recording current. Data is read by detecting and converting a leakage field occurring from the magnetic recording medium into an electric signal.

The magnetic recording medium 51 is made from a Co—Cr—Pt alloy with a residual magnetic flux density of 3400 Oe. The magnetic gap film of the reading head of the magnetic head 53 is made of an SiO₂/Si double-layer film having a high dielectric breakdown voltage. Since the magnetic head can be produced at a higher yield by using a thin magnetic gap film as compared to a conventional magnetic head using an Al₂O₃ single-layer as a magnetic gap film, a magnetic disk apparatus having a high recording density can be produced. The magnetic head of the invention is advantageous to be used in a magnetic storage apparatus having a recording density of 20 Gbit/in² or higher, and is requisite for a magnetic storage apparatus with a recording density of 40 Gbit/in² or higher.

According to the present invention, a magnetoresistive head having a thin gap film can be provided at a high yield. By combining this head as a reading head with an induction-type magnetic head as a recording head, a magnetic head and a magnetic storage apparatus adapted to a high recording density can constantly be obtained.

What is claimed is:

1. A magnetoresistive head comprising a magnetoresistive element having a magnetoresistive film for converting a magnetic signal into an electric signal and a pair of electrodes for passing a detection current to the magnetoresistive film, the magnetoresistive element being provided between an upper shielding film and a lower shielding film via an upper gap film and a lower gap film, respectively,
wherein at least one of the lower gap film or the upper gap film has a laminated structure of a highly-resistive film and an insulating film made of or mainly made of Al₂O₃, SiO₂, AlN or Si₃N₄.

2. A magnetoresistive head according to claim 1, wherein the highly-resistive film is made of or mainly made of Si, SiC, ZnO, Ni—O, Fe—O or Co—O.

3. A magnetoresistive head according to claim 1, wherein an electric resistance of the highly-resistive film is 0.01 Ωcm or higher.

4. A magnetic head comprising a combination of the magnetoresistive head of claim 1 and an inductive thin-film head.

5. A magnetoresistive head according to claim 2, wherein an electric resistance of the highly-resistive film is 0.01 Ωcm or higher.

6. A magnetic head comprising a combination of the magnetoresistive head of claim 2 and an inductive thin-film head.

7. A magnetic head comprising a combination of the magnetoresistive head of claim 3 and an inductive thin-film head.

8. A magnetic storage apparatus comprising:
a magnetic recording medium;
a magnetic head for recording and reading data on/from the magnetic recording medium;
a mechanism for supporting and aligning the magnetic head at a desired radial position on the magnetic recording medium; and
a recording/reading signal processing system for processing a recording signal and a reading signal,
wherein the magnetic head comprises a magnetoresistive element having a magnetoresistive film for converting a magnetic signal into an electric signal and a pair of electrodes for passing a detection current to the magnetoresistive film, the magnetoresistive element being provided between an upper shielding film and a lower shielding film via an upper gap film and a lower gap film; and the lower gap film and/or the upper gap film has a laminated structure of a highly-resistive film and an insulating film made of or mainly made of Al₂O₃, SiO₂, AlN or Si₃N₄.

9. A magnetic storage apparatus according to claim 8, wherein the highly-resistive film is made of or mainly made of Si, SiC, ZnO, Ni—O, Fe—O or Co—O.

10. A magnetic storage apparatus according to claim 8, wherein an electric resistance of the highly-resistive film is 0.01 Ωcm or higher.
